(19) United States
(12) Patent Application Publication
(10) Pub. No.: US 2009/0053518 A1
(43) Pub. Date: Feb. 26, 2009

(54) Sheet for Forming a Protective Film for Chips

(75) Inventors: Naoya Saiki, Tokyo (JP); Tomonori Shinoda, Tokyo (JP); Osamu Yamazaki, Tokyo (JP)

Correspondence Address: THE WEBB LAW FIRM, P.C., 700 KOPPERS BUILDING, 436 SEVENTH AVENUE, PITTSBURGH, PA, 15219, US

(73) Assignee: LINTEC CORPORATION, Tokyo (JP)

(21) Appl. No.: 12/294,389

(22) PCT Filed: Mar. 23, 2007
(86) PCT No.: PCT/JP2007/056082

§ 371 Date: Sep. 24, 2008

(30) Foreign Application Priority Data
Mar. 28, 2006 (JP) 2006-087925

(51) Int. Cl. B32B 33/00

(52) U.S. Cl. 428/352

(57) ABSTRACT

Described is a sheet for forming a protective film, which can be used suitably in a process where marking is made on the protective film formed on work such as a wafer and the like. The sheet includes a release sheet and a protective film forming layer provided on the release surface of the release sheet, wherein the protective film forming layer includes 100 parts by weight of an epoxy resin, 50 to 200 parts by weight of a binder polymer, and 100 to 2,000 parts by weight of fillers, 30% by weight or more of total 100% by weight of the said epoxy resin being selected from epoxy resins represented by the following formulae (I) and (II);

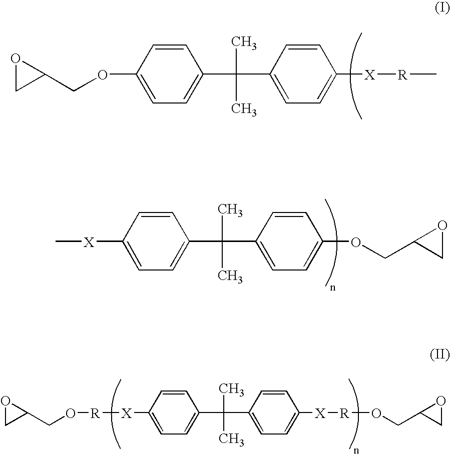

wherein, X's are —O—, —OCH(CH₃)O— and the like; R's are a polyether skeleton and the like; and n's are in the range of 1 to 10.

### TECHNICAL FIELD

The present invention relates to a sheet for forming a protective film for chips, which is used to form a protective film on the back surface of such a chip as a semiconductor chip.

### BACKGROUND ART

In recent years, production of a semiconductor device by use of a so-called face down mounting process is being carried out. In the face down process, there is used a chip which has a convex portion called a bump on the circuit face side in order to secure electrical continuity and is connected to the substrate through the convex portion of the circuit face side.

Such semiconductor devices are generally produced though the following steps:
(1) forming a circuit on a surface of a semiconductor wafer by etching or the like and providing a bump on the appointed position of the circuit surface;
(2) grinding the back surface of semiconductor wafer to have a given thickness;
(3) fixing the back surface of semiconductor wafer onto a dicing sheet which is tautly supported by a ring frame, and dicing the wafer to separate each circuit by the use of a dicing saw to obtain semiconductor chips; and
(4) picking up the semiconductor chips to mount them face down on a prescribed substrate and sealing the chip in a resin or coating the back surface of chip with a resin according to necessity for chip protection, thereby obtaining a semiconductor device.

The resin sealing is performed by a potting method where an adequate amount of resin is dripped on the chip and cured, or by a molding method which uses a mold. However, the potting method has a difficulty in dripping a proper amount of resin. The molding method involves cleaning of the mold and the like, which will require higher equipment and operating costs. As for resin coating, it is difficult to coat a proper amount of resin evenly and this may sometimes lead to fluctuations of quality. Thus, there has been a desire for the development of a technique, which enables easily forming a highly uniform protective film on the back surface of the chip.

Further, in the grinding of the back surface of a wafer in step (2) described above, minute streaky scratches are formed on the back surface of the chip due to mechanical grinding. The minute scratches may cause cracks, occurring during the dicing step (3) or after packaging. Thus, heretofore, chemical etching was sometimes required after the mechanical grinding in order to remove the minute scratches. However, the chemical etching, of course, requires equipment and operating costs, causing a cost increase. Therefore, development of a technique has been desired, which resolves adverse effects caused by such minute scratches, even if they are formed on the back surface of chips as a result of mechanical grinding.

As a technique to satisfy these desires, the present applicants and others disclosed in Patent Document 1 “a sheet for forming a protective film for chips, comprising a release sheet and a protective film forming layer, the layer being formed on the release surface of the release sheet and comprising a thermally curable component and/or an energy-ray curable component and a binder polymer component.” In Patent Document 2 is disclosed formation of a curable adhesive layer on the protective film forming layer, in order to improve, in the invention of the Patent Document 1, adhesion between the protective film formed by curing the protective film forming layer and the adherend, wafer (chips).

In a process using the sheet for forming a protective film for chips, the sheet is adhered onto the wafer and the release sheet is peeled off to form a protective film forming layer on the wafer. Then the protective film forming layer on the wafer is cured by heating and the like to become a protective film and, thereon, item numbers and the like are marked. Thereafter, the wafer having the protective film is fixed on the dicing sheet, diced, and picked-up to afford chips with a protective film. As the marking method, a laser marking method is generally used, which scrapes the surface of a protective film with a laser light irradiation.

[Patent Document 1] JP-A-2002-280329

[Patent Document 2] JP-A-2004-214288

### DISCLOSURE OF THE INVENTION

### Problems to be Solved by the Invention

In the process described above, there have been cases of occurrence of wafer warpage because the protective film shrinks during the course of curing. It is difficult in marking to focus the laser light on these wafers with warpage and, thus, marking with high accuracy was not possible.

The present invention was made in light of the prior art and has an object of providing a sheet for forming a protective film which can be used suitably for a process, whereby marking is made on the protective film formed on work such as a wafer and the like.

The present invention, which is directed to solve these problems, is summarized as follows:

(1) A sheet for forming a protective film for chips, comprising a release sheet and a protective film forming layer provided on the release surface of the release sheet, wherein the protective film forming layer comprises 100 parts by weight of an epoxy resin, 50 to 200 parts by weight of a binder polymer and 100 to 2,000 parts by weight of fillers, 30% by weight or more of total 100% by weight of the said epoxy resin being selected from epoxy resins represented by the following formulae (I) and (II):

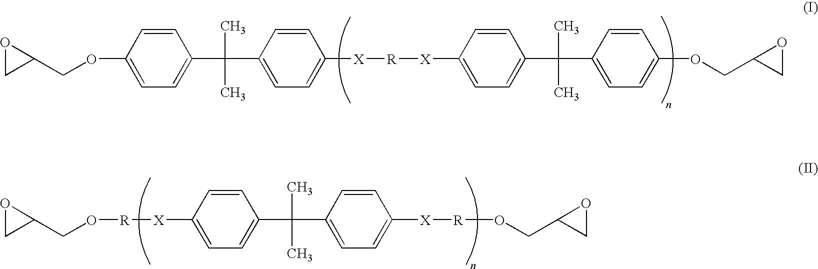

wherein, X's may be the same or different and each are a divalent group selected from —O—, —COO—, —OCO— and —OCH(CH₃)O—;

R's may be the same or different and each are a divalent group selected from alkylene, polyether skeleton, polybutadiene skeleton and polyisoprene skeleton; and

n's are in the range of 1 to 10:

(2) The sheet for forming a protective film for chips according to (1), wherein the loss tangent (tan δ) at the glass transition temperature of the cured protective film forming layer is 0.2 or larger.

### EFFECT OF THE INVENTION

According to the sheet for forming a protective film for chips of the present invention, there is almost no shrinkage of the protective film forming layer after the sheet is adhered onto the wafer followed by curing and, thus, warpage of the wafer is suppressed. As a result, when marking is performed the protective film with a laser light, it becomes possible to carry out marking with high accuracy.

### BEST MODE FOR CARRYING OUT THE INVENTION

Hereafter the present invention will be described in more specifically. The sheet for forming a protective film for chips according to the present invention comprises a release sheet and a protective film forming layer provided on the release surface of the release sheet.

As the release sheet, films of polyethylene, polypropylene, polybutene, polybutadiene, polymethylpentene, polyvinyl chloride, a vinyl chloride copolymer, polyethylene terephthalate, polyethylene naphthalate, polybutylene terephthalate, polyurethane, an ethylene-vinyl acetate copolymer, an ionomer resin, an ethylene-(meth)acrylic acid copolymer, an ethylene-(meth)acrylate copolymer, polystyrene, polycarbonate, polyimide, a fluororesin or the like may be used. Films of a crosslinked product of the above polymers, or laminated films of these polymers may also be used.

When using the sheet for forming a protective film for chips of the present invention, the protective film forming layer is transferred onto the semiconductor wafer after the film-forming layer is thermally cured and the release sheet is peeled-off. Therefore, the release sheet has to resist the heat at the time of the thermal curing of the protective film forming layer and, thus, thermally stable films of polymethylpentene, polyethylene naphthalate, and polyimide are preferably used. For easier peeling of the release sheet off the protective film forming layer, the release sheet has a surface tension of preferably 40 mN/m or less, more preferably 37 mN/m or less, particularly preferably 35 mN/m or less. A release sheet having such a low surface tension can be obtained by appropriately selecting materials or by coating a silicone resin and the like on the surface of the release sheet for a release treatment.

The release sheet has a thickness of usually 5 to 300 μm, preferably 10 to 200 μm, and particularly preferably 20 to 150 μm.

The protective film forming layer is provided on the release surface of the release sheet. The sheet for forming a protective film for chips of the present invention may have a two-layered structure composed of the protective film forming layer and the release sheet, and may also have a three-layered structure further having a release sheet laminated on the protective film forming layer. In the three-layered structure, thickness of the two release sheets is preferably different. In such a case, the thinner sheet is peeled off more easily. Thus, when the sheet for forming a protective film for chips is used, it becomes easier to have the protective film forming layer left adhered to one of the two release sheets and to have a surface thereof exposed.

The protective film forming layer is thermally curable and is adhered to an adherend such as a semiconductor wafer and subsequently cured to form a protective film on the adherend.

The protective film forming layer comprises an epoxy resin, a binder polymer, and fillers as essential components and may contain other components as necessary.

Of total 100% by weight of the epoxy resin, 30% by weight or more, preferably 40% by weight or more, more preferably 45 to 95% by weight, particularly preferably 50 to 90% by weight, is selected from epoxy resins represented by the following Formulae (I) and (II):

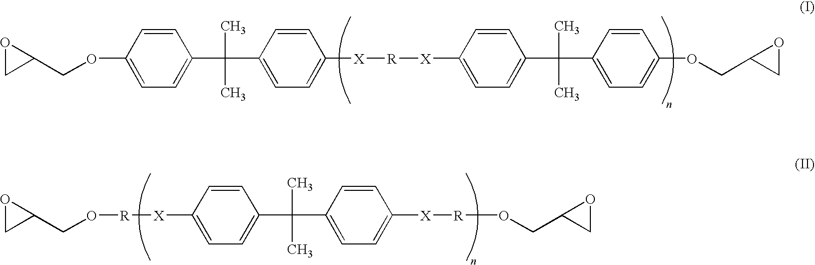

wherein X's may be the same or different and each are a divalent group selected from —O— (ether), —COO— (ester), —OCO— (ester) and —OCH(CH₃) O— (acetal), and is preferably —O— or —OCH(CH₃)O—.

R's may be the same or different and each are a divalent group selected from an alkylene, polyether skeleton, polybutadiene skeleton and polyisoprene skeleton, wherein the alkylene and polyether skeleton may each have a side chain or have a structure containing a cycloalkane skeleton. The divalent group, R, is preferably an alkylene or ether skeleton having a structural formula such as (CH₂CH₂)—(OCH₂CH₂)ₘ— and —(CH(CH₃)CH₂)—(OCH(CH₃)CH₂)— (m is 0 to 5). Specific examples thereof include alkylenes such as ethylene and propylene; polyether skeletons such as an ethyleneoxyethyl group, a di(ethyleneoxy)ethyl group, a tri(ethyleneoxy)ethyl group, a propyleneoxypropyl group, a di(propyleneoxy)propyl group and a tri(propyleneoxy)propyl group.

The integer n's are in the range of 1 to 10, preferably 1 to 8, particularly preferably 1 to 5.

Hereafter, the epoxy resins represented by formula (I) or (II) may specifically be referred to as “flexible epoxy resin”. The epoxy equivalent of the flexible epoxy resin is preferably 100 to 1,000 g/eq, more preferably 200 to 600 g/eq. Further, the flexible epoxy resin is such that the cured material thereof has a glass transition temperature (Tg) of preferably 100° C. or lower, more preferably 80° C. or lower.

When the flexible epoxy resins are used as the epoxy resin, the glass transition temperature of the thermally cured protective film tends to become lower and the loss tangent (tan δ) of the cured protective film at the glass transition temperature tends to become larger. When temperature is varied above the glass transition temperature of the protective film, the protective film becomes elastic and the wafer tends to warp. When tan δ at the glass transition temperature becomes larger, the stress tends to relax easily in a short time even if expansion or contraction occurred due to heating. Thus, even when a protective film forming layer is cured after being adhered onto the semiconductor wafer, warping of the wafer is not induced. Examples of such flexible epoxy resins include EXA-4850-150 and EXA-4850-1000 produced by DIC Corporation and Denacol EX-250 and EX-250L produced by Nagase ChemteX Corporation.

As the epoxy resin used in the present invention, the flexible epoxy resins may be used singly, but in order to properly adjust the tackiness before curing, strength or abrasion resistance of the cured film or the like, other general-purpose epoxy resins may be blended.

However, when the proportion of the flexible epoxy resin is too small, tan δ after curing becomes low resulting in lowering of a stress relaxation property of the protective film, which may cause warpage of the semiconductor wafer.

As the general-purpose epoxy resin used together with the flexible epoxy resin, those having a molecular weight of 300 to 2,000 is usually preferable. Examples thereof include an epoxy resin that is liquid in the standard state and has a molecular weight of 300 to 1,000, preferably 330 to 800; an epoxy resin that is solid in the standard state and has a molecular weight of 400 to 2,500, preferably 800 to 2,000; and a blend thereof. Further, the epoxy equivalent of these general-purpose epoxy resins is usually 50 to 5,000 g/eq. Specific examples of such epoxy resins include glycidyl ethers of phenols such as bisphenol A, bisphenol F, resorcinol, phenyl novolac and cresol novolac; epoxy resins containing dicyclopentadiene skeleton; glycidyl ethers of carboxylic acids such as phthalic acid, isophthalic acid and tetrahydrophthalic acid; glycidyl-type or alkylglycidyl-type epoxy resins obtained by substituting an active hydrogen bonded to nitrogen atom of aniline isocyanurate and the like with a glycidyl group; so-called alicyclic epoxides having an epoxy group introduced therein through, for example, oxidation of an intramolecular C—C double bond, such as vinylcyclohexane diepoxide, 3,4-epoxycyclohexylmethyl-3,4-dicyclohexane carboxylate and 2-(3,4-epoxy)cyclohexyl-5,5-spiro(3,4-epoxy)cyclohexane-m-dioxane.

Among these, bisphenol glicidyl type epoxy resins, o-cresol novolac type epoxy resins, phenol novolac type epoxy resins, and dicyclopentadiene skeleton-containing epoxy resins are preferably used.

These general-purpose epoxy resins may be used singly or in combination of two or more kinds. Further, it is possible to use modified resins, obtained by modifying beforehand the general-purpose epoxy resins. These modified resins are especially referred to as alloy-modified resins or rubber blend-modified resins.

The epoxy resin used in the present invention is preferably obtained by mixing the flexible epoxy resin with the general-purpose epoxy resin so that the average epoxy equivalent preferably thereof falls in the range of 200 to 800 g/eq, more preferably 300 to 800 g/eq, particularly preferably 500 to 700 g/eq. When the average epoxy equivalent is 200 g/eq or less, its shrinkage upon thermal curing may become larger, possibly resulting in warpage of the wafer and lowering of the adhesive strength. On the other hand, when the average epoxy equivalent is 800 g/eq or larger, the crosslink density after curing may become lower, possibly resulting in an unsatisfactory adhesive strength.

The protective film forming layer comprises, in addition to the epoxy resins, a binder polymer and fillers as essential components.

The binder polymer component is used to provide adequate tackiness to the protective film forming layer and to improve operability of the sheet. The weight average molecular weight of the binder polymer is usually in the range of 50,000 to 2,000,000, preferably 100,000 to 1,500,000, particularly preferably 200,000 to 1,000,000. When the molecular weight is too low, formation of the sheet becomes unsatisfactory and when the molecular weight is too high, compatibility of the binder polymer with other components becomes worse and, as a result, formation of a uniform sheet is interrupted. As such a binder polymer, for example, an acrylic polymer, a polyester resin, a urethane resin, a silicone resin, a rubber-based polymer or the like may be used. Especially, an acrylic polymer is preferably used.

Examples of the acrylic polymer include a (meth)acrylate copolymer comprising structural units derived from a (meth)acrylate monomer and a (meth)acrylic acid derivative. Preferably used as the (meth)acrylate monomer is an alkyl (meth)acrylate with the alkyl group having 1 to 18 carbon atoms, for example, methyl (meth)acrylate, ethyl (meth)acrylate, propyl (meth)acrylate, butyl (meth)acrylate, and the like. Examples of the (meth)acrylic acid derivative include (meth)acrylic acid, glycidyl (meth)acrylate and hydroxyethyl (meth)acrylate.

When a glycidyl group is introduced into the acrylic polymer by use of glycidyl methacrylate and the like as structural units, its compatibility with the epoxy resin is improved, and the glass transition temperature (Tg) of the cured protective film forming layer after curing becomes higher, resulting in improved heat resistance. In addition, when a hydroxyl group is introduced into the acrylic polymer by use of hydroxyethyl acrylate and the like as structural units, adhesion and tackiness towards the wafer can be controlled.

When the acrylic polymer is used as the binder polymer, the weight average molecular weight of the polymer is preferably 100,000 or higher, particularly preferably 150,000 to 1,000,000. The glass transition temperature of the acrylic polymer is usually 20° C. or lower, preferably −70 to 0° C., and the polymer has tackiness at ordinary temperature (23° C.).

The protective film forming layer contains the binder polymer component in an amount of 50 to 200 parts by weight, preferably 60 to 190 parts by weight, more preferably 90 to 150 parts by weight, particularly preferably 100 to 130 parts by weight, per 100 parts by weight of the epoxy resin.

Mixing the epoxy resin and the binder polymer component in these ratios causes an adequate tackiness before curing, whereby an adhering work becomes steady, and leads to providing a protective film with superior film strength after curing.

The protective film forming layer further contains fillers in addition to the components. Examples of the fillers include inorganic fillers such as silica including, for example, crystalline silica, fused silica and synthetic silica; alumina; and glass balloons. By addition of inorganic fillers to the protective film forming layer, the thermal expansion coefficient of the cured layer gets closer to that of the wafer and, as a result, warpage of the wafer during processing can be decreased. As the fillers, the synthetic silica is preferable and especially suitable is the synthetic silica from which an α ray source, which causes malfunction of the semiconductor device, has been removed as thoroughly as possible. As for the shape of fillers, any of spherical, needle, or irregular type is usable, and especially preferable are spherical fillers, which can adopt a close-packed structure.

Furthermore, as the fillers added to the protective film forming layer, the following functional fillers may be added in addition to the inorganic fillers described above. For example, with an aim to impart electrical conductivity after die bonding, the following may be added: electro-conductive fillers such as gold, silver, copper, nickel, aluminum, stainless steel, a ceramic and those obtained by coating nickel, aluminum or the like by silver. Further, in order to impart heat conductivity, the following may be added: heat-conductive materials, for example, metals such as gold, silver, copper, nickel, aluminum, stainless steel, silicon and germanium and alloys of these metals.

These fillers are contained in an amount of 100 to 2,000 parts by weight, preferably 150 to 1,800 parts by weight, more preferably 200 to 1,400 parts by weight, particularly preferably 250 to 500 parts by weight, per 100 parts by weight of the epoxy resin.

By addition of fillers to the protective film forming layer, strength of the cured protective film increases and the ability to be marked by the laser marking process improves.

In addition to the additives described above, it is preferable that a thermally activatable latent epoxy resin curing agent is contained as auxiliaries.

The thermally activatable latent epoxy resin curing agent is one which does not react with an epoxy resin at room temperature but, when heated above a certain temperature, becomes activated to react with the epoxy resin. Examples of methods to activate the thermally activatable latent epoxy resin curing agent include a method where reactive species (anions, cations) are formed by a chemical reaction caused by heating; a method where the curing agent, dispersed stably in the epoxy resin at around room temperature, becomes compatible and gets dissolved in the epoxy resin at high temperature to initiate the curing reaction; a method where a curing agent included in molecular sieves gets eluted at high temperature to initiate the curing reaction; and a method where microcapsules are used.

Specific examples of the thermally activatable latent epoxy resin curing agent used in the present invention include various onium salts and active hydrogen compounds having a high-melting point such as a dibasic acid dihydrazide, dicyandiamide, an amine adduct curing agent and an imidazole compound. These thermally activatable latent epoxy resin curing agents may be used singly or in a combination of two or more kinds. The thermally activatable latent epoxy resin curing agent is used in an amount of preferably 0.1 to 20 parts by weight, more preferably 0.2 to 10 parts by weight, particularly preferably 0.3 to 5 parts by weight, per 100 parts by weight of the epoxy resin.

The protective film forming layer may further contain pigments or dyes. The pigments and dyes are added mainly to enhance recognizability of the marking on the surface of the cured film (protective film), even though addition of pigments and dyes may regulate the elastic modulus of the cured film to some extent. Examples of such pigments include carbon blacks and various inorganic pigments. The examples also include various organic pigments such as azo compounds, indanthrenes, indophenols, phthalocyanines, indigoids, nitroso compounds, xanthanes and oxyketones. Coloring of the protective film forming layer with pigments or dyes leads to improving appearance of IC chips. In order to differentiate the IC chips, the surface of the protective film is most often subjected to marking by a laser marking method. In doing so, the contrast at the laser-marked portion is stressed to improve its visibility. The amount of pigments and dyes to be added varies depending on their type, but generally the suitable amount is about 0.1 to 20% by weight, preferably about 0.2 to 15% by weight, based on the all components of the protective film forming layer.

The protective film forming layer may contain a crosslinking agent such as organic polyfunctional isocyanates, organic polyfunctional imines and organometallic chelate compounds in order to adjust its cohesive force before curing.

An antistatic agent may be added in the protective film forming layer. Addition of the antistatic agent suppresses static electricity to improve reliability of the chips. Furthermore, addition of a phosphoric acid compound, a bromo compound, a phosphorous compound or the like imparts flame retardancy, whereby reliability as a package is improved.

Because the protective film forming layer contains fillers, a clear mark can be formed on the cured film (protective film) by a laser marking method and the like. Namely, in these cases, sufficient difference in contrast between the marked portion and unmarked portion is obtained, whereby the mark become more recognizable.

The thickness of the protective film forming layer is preferably 3 to 100 μm, more preferably 10 to 60 μm.

The protective film obtained by curing the protective film forming layer in the present invention has a large tan δ at the glass transition temperature and, therefore, the wafer does not warp when the sheet for forming a protective film is adhered onto the semiconductor wafer and cured. The tan δ of the cured protective film is preferably 0.2 or larger, more preferably 0.25 to 3.

It is hard for the glass transition temperature of the protective film to appear as a definite inflexion point because the protective film is a mixture. Thus, the temperature at which tan δ shows the maximum value in the viscoelasticity measurement was regarded as the glass transition temperature. The glass transition temperature of the protective film obtained by thermally curing the protective film forming layer is, although not particularly limited to, preferably in the range from 0 to 120° C., more preferably room temperature to 90° C. By increasing the content of the flexible epoxy resin in the whole epoxy resin, tan δ value at the glass transition temperature tends to become larger.

The sheet for forming a protective film for chips of the present invention may be obtained by coating a composition comprising the components described above on the release sheet by publicly known means such as a gravure coater, a die coater, a reverse coater, a knife coater, a roll knife coater, a kiss roll coater, an air knife coater and a curtain coater, followed by drying. The sheet for forming a protective film for chips of the present invention may also be obtained by transferring a protective film forming layer onto the release sheet, wherein the protective film forming layer is formed by coating the composition by the same means as above on another release sheet and following drying.

Next, a marking method by use of the sheet for forming a protective film for chips of the present invention will be described.

First, the sheet for forming a protective film for chips is adhered onto the back surface of a semiconductor wafer having a circuit on its surface. It is preferable to thermally compression-bond the sheet for forming a protective film for chips onto the back surface of the wafer in order to obtain a satisfactory adhesive strength.

The sheet for forming a protective film for chips may have been cut beforehand in the shape of the semiconductor wafer, to which the sheet will be adhered. The sheet for forming a protective film for chips may also be cut along the outer circumference of the semiconductor wafer after the sheet is adhered onto the semiconductor wafer.

Next, the protective film forming layer is thermally cured. The condition of thermal curing is suitably selected according to the curing temperature of the epoxy resin used. In addition, the protective film forming layer may be thermally cured either with the release sheet still adhered or after the release sheet is peeled off.

Thereafter, marking on the cured film (protective film) is performed. Marking is done by scraping the protective film on the back surface by a laser light, corresponding to the circuit formed on the wafer surface. This marking by use of a laser light is carried out according to a publicly known method. Marking may be performed either with the release sheet still adhered or after the release sheet is peeled off.

Finally, dicing of the semiconductor wafer into individual circuits is carried out to afford semiconductor chips having a protective film on the back surface and with markings on the protective film. Dicing of the wafer is carried out by publicly known methods using dicing blades or the like.

### EXAMPLES

Hereafter, the present invention will be described with reference to examples. However, the present invention is not limited to these examples.

The binder polymer, the epoxy resins, the fillers, and other components are shown below.

### A: Binder Polymer

Acrylic polymer (copolymer of 55 parts by weight of butyl acrylate, 15 parts by weight of methyl methacrylate, 20 parts by weight of glycidyl methacrylate, and 15 parts by weight of 2-hydroxyethyl acrylate; weight average molecular weight, 900,000; glass transition temperature, −28° C.)

### B: Epoxy Resin

B1: liquid bisphenol A type epoxy resin (molecular weight, ca. 370; epoxy equivalent, 180 to 200 g/eq)

B2: solid bisphenol A type epoxy resin (molecular weight, ca. 1,600; epoxy equivalent, 800 to 900 g/eq)

B3: dicyclopentadiene type epoxy resin (produced by DIC Corporation; trade name, Epiclon HP-7200HH)

B4: epoxy resin containing an ethylene glycol chain (produced by DIC Corporation; trade name, Epiclon EXA-4850-150, a compound represented by Formula I)

B5: epoxy resin containing an ethylene glycol chain (produced by Nagase ChemteX Corporation; trade name, Denacol EX-250, a compound represented by Formula II)

### C: Silica Filler (A Blend of a Fused Silica Filler (Average Particle Size, 8 μm) and a Synthetic Silica Filler (Average Particle Size, 0.5 μm) in a 9:1 Weight Ratio)

### D: Thermally Activatable Latent Epoxy Resin Curing Agent

D1: dicyandiamide

D2: 2-phenyl-4,5-dihydroxymethylimidazole (produced by Shikoku Chemicals Corporation, 2PHZ)

### E: Pigment

Carbon Black (average particle size, 28 nm)

Tan δ in visco-elasticity, warpage of wafer, and laser marking property were evaluated by the following methods.

### <Glass Transition Temperature, Tan δ>

The sample for measurement was a cured sheet obtained by stacking the protective film forming layers prepared in Examples or Comparative Examples so as to be 100 μm in thickness, followed by heating at 130° C. for 2 hours. Viscoelasticity of this sample was measured by a viscoelasticity measuring instrument (produced by TA Instrument Ltd.; trade name, DMA Q800) at a frequency of 11 Hz in the tensile mode and in a temperature range of 0 to 250° C. with a temperature increase rate of 3° C./min. The temperature corresponding to the maximum value of tan δ (loss modulus/storage modulus) was regarded as the glass transition temperature and the maximum tan δ value designated as the tan δ value.

### <Warpage of Wafer>

The sheet for forming a protective film for chips was adhered onto a mirror wafer with 8-inch diameter and 150 μm thick (back surface, #2000 ground) by a heat laminator (produced by Taisei Laminator Co., Ltd.; trade name, First Laminator VA-400) at 70° C., followed by thermal curing at 130° C. for 2 hours. Thereafter, the wafer was placed on a smooth table with the protective film forming layer upside and the height of the portion of the wafer was measured, said portion being farthest apart from the table due to warpage of the wafer.

### <Laser Marking Property>

With use of a marking instrument (produced by Hitachi Kenki Fine Tech Co., Ltd.; trade name, YAG Laser Marker LM5000), marking was performed and evaluated for markability. When marks were confirmable with eyes all over the protective film, it was judged as “markable”. When marking was not possible became more difficult because warpage made focusing of the laser light incomplete as going nearer to periphery, it was judged as “not markable”. Further, when marking was possible but marked characters were unclear because of melting and the like, it was judged as “unclear marking”.

### Examples 1 to 3, Comparative Examples 1 to 3

Each composition shown in Table 1 below and prepared using the materials described above was coated on the release treated surface of a polyethylene terephthalate film, one side of which is release treated (produced by Lintec Corporation; trade name, SP-PET 3811; thickness, 38 μm; surface tension, less than 30 mN/m; melting point, 200° C. or higher), in such a way that the thickness after removal of the solvent became 50 μm, followed by drying at 100° C. for 1 minute to afford the sheet for forming a protective film for chips.

The Evaluations were made. The results are shown in Table 1.

TABLE 1

| | | | | Comp. | Comp. | Comp. |
|---|---|---|---|---|---|---|
| | Example 1 | Example 2 | Example 3 | Ex. 1 | Ex. 2 | Ex. 3 |
| A | 117.6 | 117.6 | 105.3 | 117.6 | 117.6 | 117.6 |
| B1 | 0.0 | 0.0 | 0.0 | 58.8 | 0.0 | 0.0 |
| B2 | 11.8 | 11.8 | 10.5 | 11.8 | 70.6 | 11.8 |
| B3 | 29.4 | 29.4 | 0.0 | 29.4 | 29.4 | 29.4 |
| B4 | 58.8 | 0.0 | 89.5 | 0.0 | 0.0 | 58.8 |
| B5 | 0.0 | 58.8 | 0.0 | 0.0 | 0.0 | 0.0 |
| B Total | 100 | 100 | 100 | 100 | 100 | 100 |
| C | 352.9 | 352.9 | 352.9 | 352.9 | 352.9 | 0 |
| D1 | 2.9 | 2.9 | 2.6 | 2.9 | 2.9 | 2.9 |
| D2 | 2.9 | 2.9 | 2.6 | 2.9 | 2.9 | 2.9 |
| E | 11.8 | 11.8 | 10.5 | 11.8 | 11.8 | 11.8 |
| Warpage of | 0.5 | 0.8 | 0.2 | 5.8 | 4.6 | 0.7 |
| wafer (mm) | | | | | | |
| Tan δ Value | 0.30 | 0.33 | 0.40 | 0.13 | 0.16 | 0.30 |
| Glass | 75 | 70 | 60 | 110 | 100 | 75 |
| transition | | | | | | |
| temperature | | | | | | |
| (° C.) | | | | | | |
| Laser marking | markable | markable | markable | not | not | unclear |
| property | | | | markable | markable | marking |

### INDUSTRIAL APPLICABILITY

According to the sheet for forming a protective film for chips of the present invention, there is almost no shrinkage of the protective film forming layer after the sheet is adhered onto the wafer followed by curing and, thus, warpage of the wafer is suppressed. As a result, when marking is performed on the protective film with a laser light, it becomes possible to carry out marking with high accuracy.

1. A sheet for forming a protective film for chips, comprising a release sheet and a protective film forming layer provided on the release surface of the release sheet, wherein the protective film forming layer comprises 100 parts by weight of an epoxy resin, 50 to 200 parts by weight of a binder polymer and 100 to 2,000 parts by weight of fillers, 30% by weight or more of total 100% by weight of the said epoxy resin being selected from epoxy resins represented by the following formulae (I) and (II); 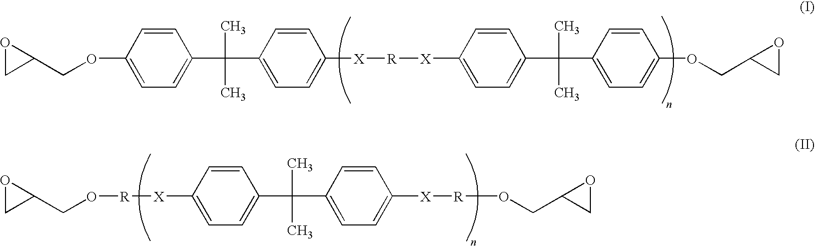
wherein, X's may be the same or different and each are a divalent group selected from —O—, —COO—, —OCO— and —OCH(CH₃)O—;
R's may be the same or different and each are a divalent group selected from an alkylene, polyether skeleton, polybutadiene skeleton and polyisoprene skeleton; and
n's are in the range of 1 to 10.

2. A sheet for forming a protective film for chips according to claim 1, wherein the loss tangent (tan δ) at the glass transition temperature of the cured protective film forming layer is 0.2 or larger.
